(19) United States
(12) Patent Application Publication
(10) Pub. No.: US 2010/0295801 A1
(43) Pub. Date: Nov. 25, 2010

(54) ELECTRONIC DEVICES

(75) Inventors: Nikolaj Bestle, Calabasas, CA (US); Claus Jorgensen, Frederiksberg (DK); Niels Emme, Hellerup (DK)

Correspondence Address: Nokia, Inc., 6021 Connection Drive, MS 2-5-520, Irving, TX, 75039, US

(73) Assignee: NOKIA CORPORATION, Espoo (FI)

(21) Appl. No.: 12/595,560

(22) PCT Filed: Apr. 10, 2007
(86) PCT No.: PCT/EP2007/003177

§ 371 Date: Jun. 24, 2010

(51) Int. Cl. G06F 3/041; G06F 3/033; G06F 3/048

(52) U.S. Cl. 345/173; 715/863

(57) ABSTRACT

A user interface for receiving touch user input to control an electronic apparatus, wherein the user interface is arranged to detect one or more touch input commands to control the activation and/or deactivation of one or more respective physical operations and/or modes of a particular physical operation of the electronic apparatus.

### TECHNICAL FIELD OF THE INVENTION

The present invention relates to user interfaces for touch user input, associated apparatus/devices, computer programs and methods. The user interfaces may be for hand-portable electronic devices, which may be hand held in use. The electronic devices may or may not provide radiotelephone audio/video functionality, music functionality (e.g. an MP3 player), digital image processing (including the capturing of a digital image), and/or controlling the operation of a remote apparatus (e.g. printer, monitor) which may be connected over a wire or over the air interface.

Such user interfaces for touch user input detect touch commands (e.g. using, for example, capacitive sensors) rather than detecting physical depression (movement in/out of the plane of the user interface) of user interface elements.

### BACKGROUND

Electronic devices with touch user interfaces are known. Devices, such as an I-Pod™, use the actuation of a slide button to activate/deactivate the user interface to allow detection of user inputs. Such a slide provides the so-called key-pad lock which is often found in current mobile phones (including Personal Digital Assistants (PDAs)).

The listing or discussion of a prior-published document in this specification should not necessarily be taken as an acknowledgement that the document is part of the state of the art or is common general knowledge.

### SUMMARY OF THE INVENTION

According to a first aspect, the present invention provides a user interface for receiving touch user input to control an electronic apparatus, wherein the user interface is arranged to detect one or more touch input commands to control the activation and/or deactivation of one or more respective physical operations and/or modes of a particular physical operation of the electronic apparatus.

The user interface may be arranged to discriminate between two or more touch input commands to control the activation/deactivation of respective two or more physical operations and/or modes of a particular physical operation of the electronic apparatus.

One or more of the touch input commands may be a swipe command. One or more of the touch input commands may be a swipe command in a particular direction.

Such directions may be associated with one or more of the eight points of a compass (e.g. N, NE, E, SE, S, SW, W, and NW). In such a case, the user input commands may not necessarily be in such absolute compass directions, but be in such directions with respect to one another.

The user interface may be arranged to comprise a touch area for a single face of the electronic apparatus such one or more touch commands are detectable on the one particular single face of the electronic apparatus.

The user interface may be arranged to comprise one or more touch areas such that a particular touch command is detectable on one or more faces of the electronic apparatus.

The user interface may be arranged to comprise one or more touch areas for multiple faces of the electronic apparatus such that a particular touch command may be detectable on two or more of the faces of the electronic apparatus.

The user interface may be arranged to comprise one or more touch areas for multiple faces of the electronic apparatus such that a particular touch command may be detectable using two or more of the faces of the electronic apparatus.

The user interface may be arranged to comprise one or more touch areas to extend continuously over multiple faces of the electronic apparatus such that a particular touch command may be detectable over two or more of the faces of the electronic apparatus.

The user interface may be arranged to comprise touch areas for different faces of the apparatus such that respective touch commands are dedicated for detection on a particular face of the apparatus.

The user interface may be arranged such that a particular touch command is registered when touch areas on different faces of the apparatus are touched in a particular order.

The user interface may be arranged such that the physical operation of the apparatus may comprise a particular physical configuration of the apparatus.

The apparatus may have first and second physical configurations, and the touch command may activate transformation of the apparatus between the first and the second configurations. This may be release of a locking mechanism which would then allow the manual manipulation of the apparatus between the configurations.

The apparatus may have first and second physical configurations, and the touch command may activate biased transformation of the apparatus between the first and the second configurations. This may not only release a locking mechanism but (e.g. magnetic/spring) bias the apparatus between the first and second configurations.

The first configuration of the apparatus may be an apparatus open configuration and the second configuration of the apparatus may be an apparatus closed configuration.

The apparatus may comprise first and second parts which overlie one another in a first configuration but which are displaced (e.g. by sliding and/or rotation about one or more axes) from each other in the second configuration.

The apparatus may comprise a third configuration and be transformable into the third configuration upon detection of a further touch input command.

The physical operations of the apparatus may comprise the activation of one or more user output elements. This may be removal of the user output elements from a locked state, and/or increasing power to the user output elements, and/or generating an output from the user output elements.

The physical operations of the apparatus may comprise the activation of one or more non-touch user input areas (e.g. keypads) and/or one or more other touch user input areas. This may be removal of the user input area from a locked state (e.g. removal of keypad lock), and/or increasing power to the user input areas, and/or allowing detection of input from the user input areas.

The user interface may be arranged such that the physical operation of the apparatus may comprise a physical function performable by the apparatus. For example, dependent upon the operations performable by the apparatus, the physical functions may include one or more of digital image processing (including the capturing of a digital image), managing a radio communication over the air interface (accepting an incoming call, initiating a new outgoing call, transmitting an MMS/SMS message), providing an audio (e.g. MP3) and/or video (watching a TV programme/movie loaded on memory readable by the apparatus or received over the air interface) output, controlling the operation of a remote apparatus (e.g. printer, monitor) which may be connected over a wire or over the air interface.

The modes of operation of a particular physical operation may be sub-aspects of the physical operation performable by the apparatus. For example, in the case of the apparatus being arranged to manage a radio communication over the air interface, a mode of physical operation may be different phone profiles and/or different aspects with regard to making a phone call (e.g. accepting/initiating/rejecting a phone call).

The apparatus may be for hand-held use and/or be a hand portable electronic apparatus.

The apparatus may be a hand-portable electronic device, such as a radiotelephone, camera and/or an audio/video player.

The user interface may comprise one or more non-touch user input areas. The user interface may comprise one or more user output areas (e.g. for audio/video output).

The user interface may extend over an entire face or a substantial portion of a face of the apparatus. The touch area may extend over an entire face or a substantial portion of a face of the apparatus.

The user interface may be arranged to comprise discrete touch areas for detection of touch input on one or more faces of the electronic apparatus. The user interface may be arranged to comprise one or more touch areas to extend continuously over multiple (e.g. two or more) faces of the electronic apparatus.

Touch areas may be configured to receive touch commands by a stylus and/or the fingers/thumb on the hand of a user.

According to a second aspect, the present invention provides a touch sensitive user interface for receiving touch user input to control an electronic apparatus, wherein the user interface is arranged to detect one or more touch input commands to control the activation and/or deactivation of one or more respective physical operations and/or modes of a particular physical operation of the electronic apparatus.

According to a third aspect, the present invention provides an electronic apparatus comprising a user interface for receiving touch user input to control an electronic apparatus, wherein the user interface is arranged to detect one or more touch input commands to control the activation and/or deactivation of one or more respective physical operations and/or modes of a particular physical operation of the electronic apparatus.

According to a fourth aspect, the present invention provides a computer program for a user interface for receiving touch user input to control an electronic apparatus, wherein the user interface is arranged to detect one or more touch input commands to control the activation and/or deactivation of one or more respective physical operations and/or modes of a particular physical operation of the electronic apparatus.

The computer program would be recorded on a carrier (e.g. memory).

A method of controlling an electronic apparatus by receiving touch user input, wherein the apparatus is arranged to detect one or more touch input commands to control the activation and/or deactivation of one or more respective physical operations and/or modes of a particular physical operation of the electronic apparatus, wherein upon detection of the touch input the apparatus is arranged to activate and/or deactivate one or more respective physical operation and/or modes of a particular physical operation of the electronic apparatus.

Any circuitry may include one or more processors, memories and bus lines. One or more of the circuitries described may share circuitry elements.

The present invention includes one or more aspects, embodiments or features in isolation or in various combinations whether or not specifically stated (including claimed) in that combination or in isolation.

The above summary is intended to be merely exemplary and non-limiting.

### BRIEF DESCRIPTION OF THE DRAWINGS

A description is now given, by way of example only, with reference to the accompanying drawings, in which:—

FIG. 1 shows a first embodiment of an electronic apparatus in a first physical configuration;

FIG. 2 shows the electronic apparatus of FIG. 1 in a second physical configuration;

FIG. 3 shows the electronic apparatus of FIG. 1 in a third physical configuration;

FIG. 4 shows a second embodiment of an electronic apparatus;

FIG. 5 shows a third embodiment of an electronic apparatus;

FIG. 6 shows a fourth embodiment of an electronic apparatus;

FIG. 7 is a schematic diagram representing internal electronic components of an apparatus according to the invention;

FIG. 8 is a flowchart representing a method according to the invention.

### DETAILED DESCRIPTION

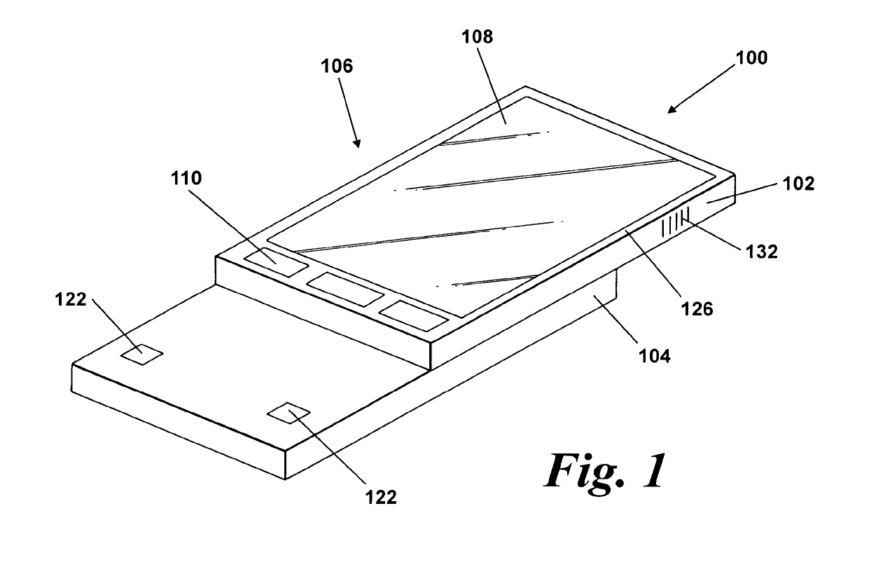

FIGS. 1 to 3 show an electronic apparatus 100 including a first part 102, a second part 104 and a user interface 106. The user interface 106 includes a touch screen 108 for user input and output, a plurality of non-touch user input areas being physical keys 110, and a user output area for audio output being a speaker 132. The touch screen is configured to receive touch commands by a stylus and/or the fingers/thumb on the user's hand. The apparatus 100 is for hand-held use and comprises the functionality of a radiotelephone, a camera and an audio/video player.

The electronic apparatus 100 is arranged to detect and discriminate between two or more touch input commands to control the activation/deactivation of two or more respective physical operations and/or modes of a particular physical operation of the electronic apparatus 100.

A touch input command may be a swipe command. The swipe command may be a swipe in a particular direction, for example a direction associated with one or more of the points of a compass (e.g. N, NE, E, SE, S, SW, W, and NW). In such a case, the user input commands may not necessarily be in such absolute compass directions, but be in such directions with respect to one another. The swipe direction may alternatively be defined as left to right, right to left, top to bottom, bottom to top etc. Additionally or alternatively, the swipe command may be a swipe in a particular shape, e.g. circular, triangular, or a swipe in the form of an alphanumeric character.

The apparatus 100 is arranged to allow a user to store certain touch input commands and associate them with physical operations and/or modes of particular physical operation of the apparatus 100. For example, the user may store a left-to-right swipe command to move the apparatus 100 from a closed physical configuration to an open physical configuration, as will be described. In this way, the apparatus 100 responds to the left-to-right swipe command by moving from the closed physical configuration to the open physical configuration, but would not respond in the same way to a right-to-left swipe command in the closed configuration. In the open configuration, the apparatus 100 may respond to a right-to-left swipe to move the apparatus 100 from the open configuration to the closed configuration. Circular (clockwise/anticlockwise swipes may be used to open/close the apparatus 100).

Let us consider the apparatus 100 arranged such that the physical operation associated with the touch command comprises a particular physical configuration of the apparatus 100.

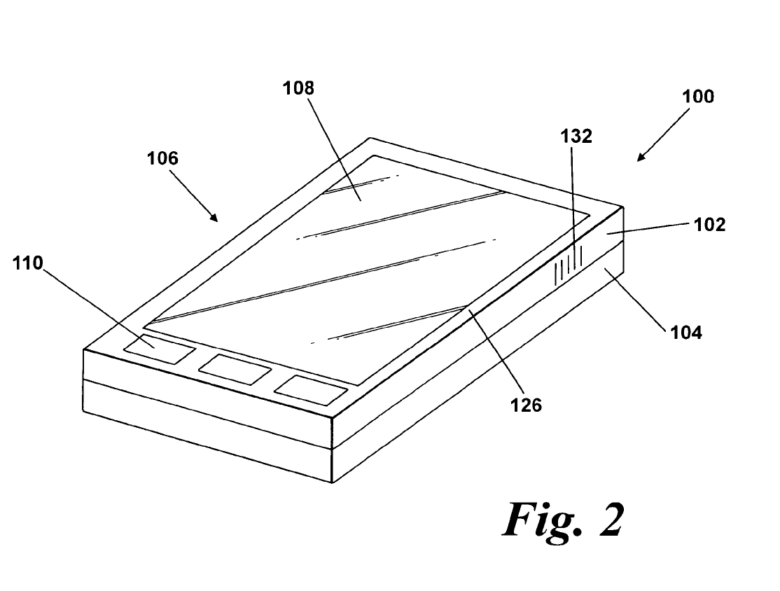

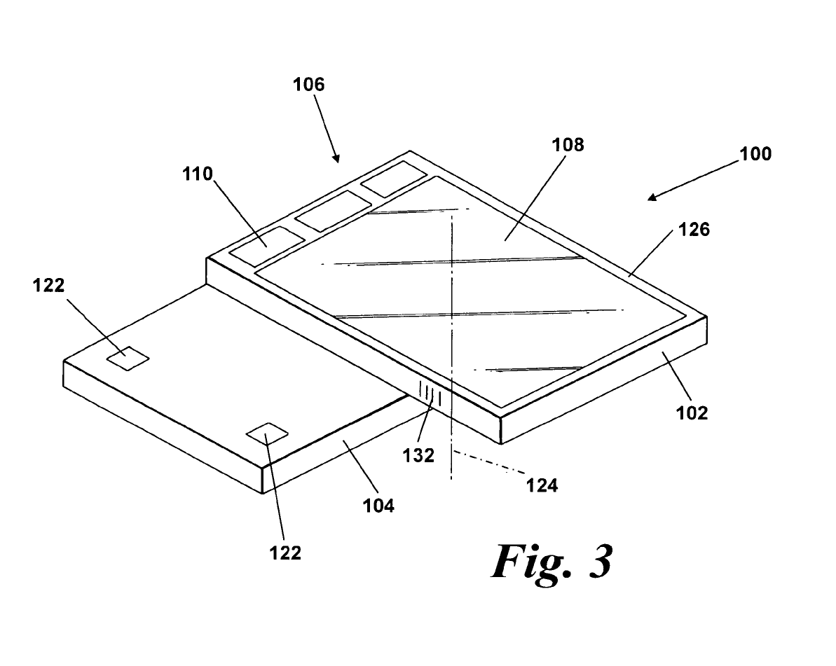

The apparatus 100 is shown in a first, open physical configuration in FIG. 1, in which the first and second parts 102, 104 overlie one another. The apparatus 100 is shown in a second, closed physical configuration in FIG. 2, in which the first and second parts 102, 104 are displaced by relative sliding. A particular touch command, for example a left-to-right swipe on the touch screen 108, activates transformation of the apparatus 100 between the first and the second physical configurations. The apparatus 100 is shown in a third physical configuration in FIG. 3, in which the first and second parts 102, 104 are displaced by relative rotation about an axis 124. The apparatus 100 is transformable into the third physical configuration upon detection of a further touch input command, for example a right-to-left swipe on the touch screen 108.

In one embodiment, the apparatus 100 is arranged to release a locking mechanism 122 in response to the touch command which then allows the manual manipulation of the apparatus 100 between the physical configurations. In another embodiment, the touch command activates biased transformation of the apparatus 100 between the physical configurations. This not only releases the locking mechanism 122 but also (e.g. by use of magnets/springs) biases the apparatus 100 between the physical configurations.

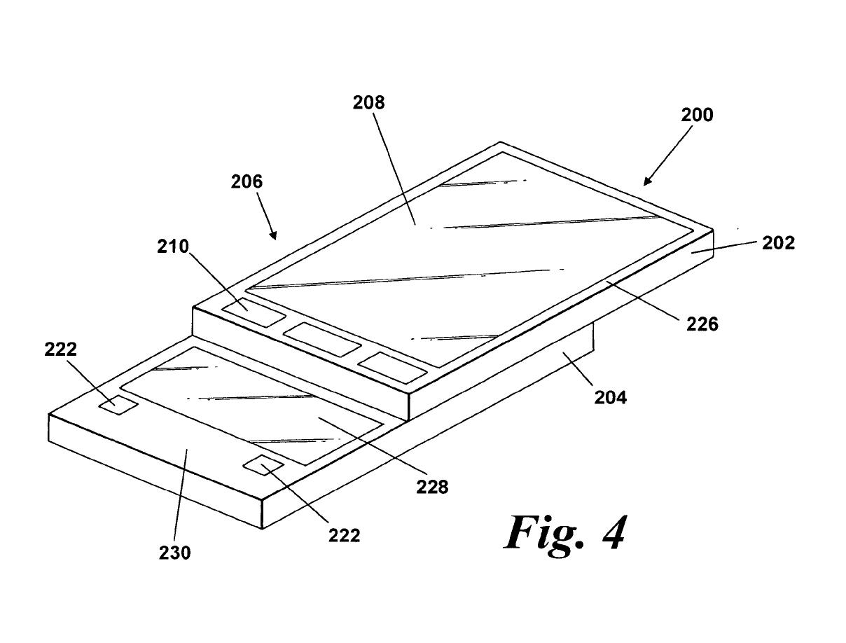

The apparatus 100 of FIG. 1 is arranged to comprise a touch screen 108 for a single face 126 of the electronic apparatus 100 such that one or more touch commands are detectable on the one particular single face 126 of the electronic apparatus 100. FIG. 4 shows a second embodiment of an electronic apparatus 200 in which the user interface 206 is arranged to comprise two touch screens 208, 228 such that a particular touch command is detectable on two separate faces 226, 230 of the electronic apparatus 200.

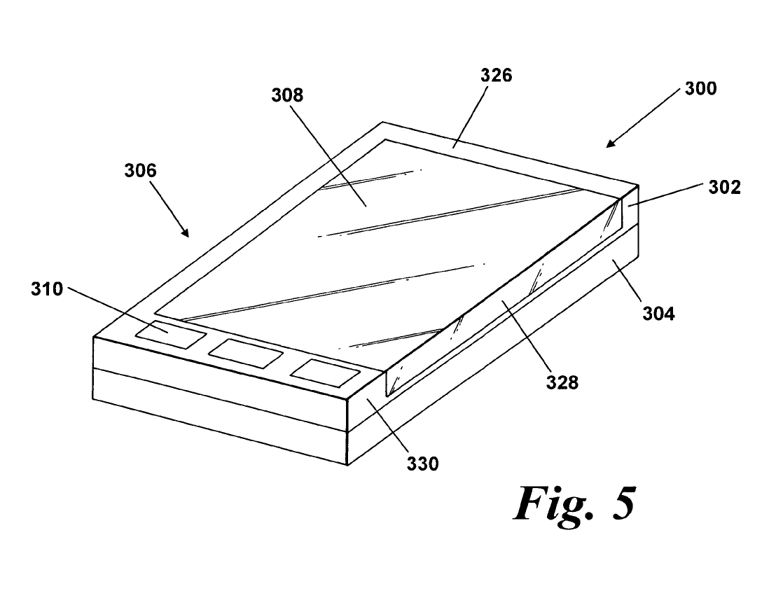

FIG. 5 shows a third embodiment of an electronic apparatus 300 in which the user interface 306 is arranged to comprise two touch screens 308, 328 which extend continuously over multiple faces 326, 330 of the electronic apparatus 300 such that a particular touch command is detectable over the two faces 326, 330 of the electronic apparatus 300.

The apparatus of FIGS. 4 and 5 may be arranged such that a touch command is registered when touch screens on different faces of the apparatus are touched in a particular order.

In the embodiments described above, touch input commands are used to control the activation and/or deactivation of physical operations of the apparatus, with the physical operations comprising particular physical configurations of the apparatus.

In other embodiments, the physical operations of the apparatus may comprise the activation and/or deactivation of user output elements, for example the touch screen 108. In this case, the apparatus is arranged to move the user output elements to or from a locked state, and/or to increase or decrease power to the user output elements, and/or to generate or refrain from generating an output from the user output elements, in response to the touch commands.

The physical operations of the apparatus may comprise the activation and/or deactivation of one or more non-touch user input areas (e.g. the physical keys 110) and/or one or more other touch user input areas (e.g. the touch screen 108). In this case, the apparatus is arranged to move the user input area to or from a locked state (e.g. using a keypad lock), and/or to increase or decrease power to the user input areas, and/or allow or prevent detection of input from the user input areas, in response to the touch commands.

The physical operation of the apparatus may comprise a physical function performable by the apparatus. For example, dependent upon the operations performable by the apparatus, the physical functions may include one or more of digital image processing (including the capturing of a digital image), managing a radio communication over the air interface (accepting an incoming call, initiating a new outgoing call, transmitting an MMS/SMS message), providing an audio (e.g. MP3) and/or video (watching a TV programme/movie loaded on memory readable by the apparatus or received over the air interface) output, controlling the operation of a remote apparatus (e.g. printer, monitor) which may be connected over a wire or over the air interface.

If desired, the user may store a swipe command to access a particular function of the apparatus which he somehow associates with that function. For example, the user may swipe the letter “t” to access a text message (SMS) creation function, or the letter “m” to access a music-player function.

The modes of operation of a particular physical operation may be sub-aspects of the physical operation performable by the apparatus. For example, in the case of the apparatus being arranged to manage a radio communication over the air interface, a mode of physical operation may be different phone profiles and/or different aspects with regard to making a phone call (e.g. accepting/initiating/rejecting a phone call).

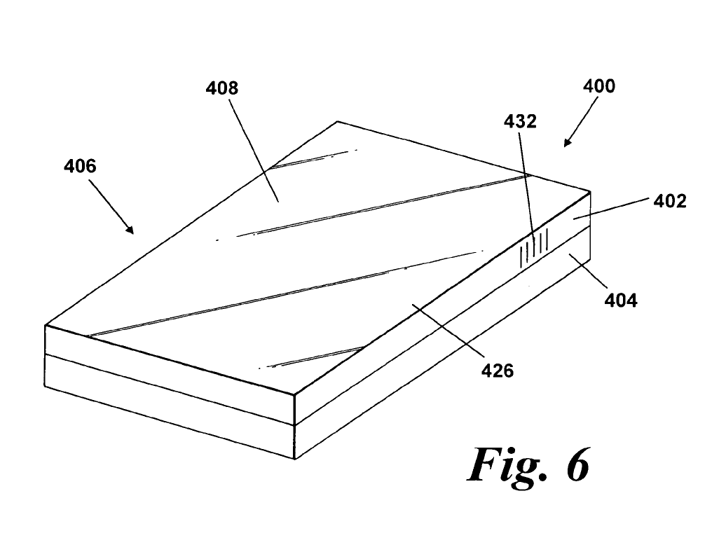

FIG. 6 shows a fourth embodiment of an electronic apparatus 400 in which the user interface 406 comprises a touch screen 408 which extends over an entire face 426 of the apparatus 400.

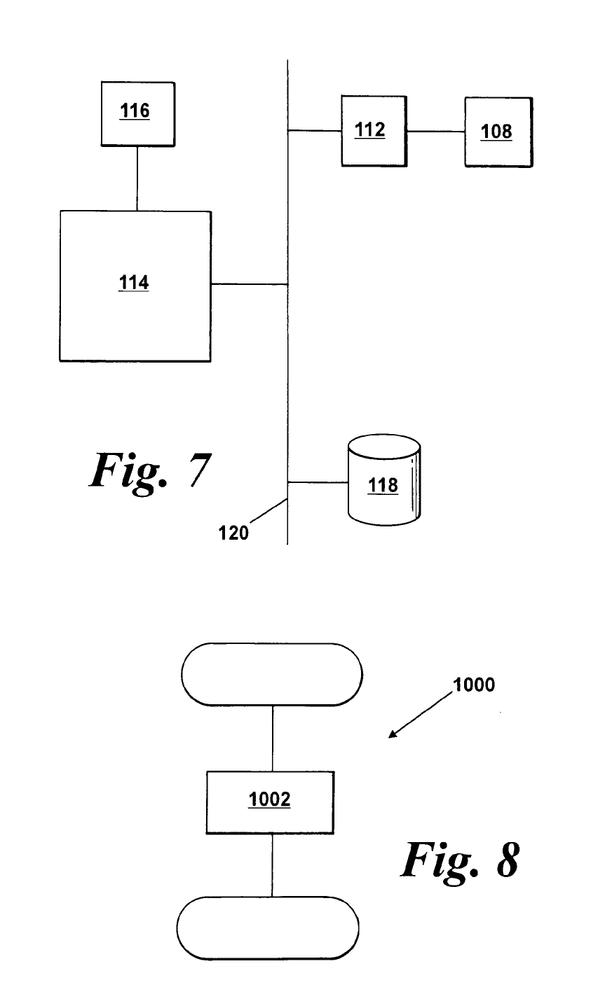

FIG. 7 is a schematic diagram representing internal electronic components of the apparatus.

The apparatus includes processing circuitry 114 having random access memory (RAM) 116. A bus 120 connects the processing circuitry 114 to hard disk 118 and to touch screen control circuitry 112, which is connected to touch screen 108.

FIG. 8 is a flowchart representing a method 1000 of controlling an electronic apparatus by receiving touch user input, wherein the apparatus is arranged to detect one or more touch input commands to control the activation and/or deactivation of one or more respective physical operations and/or modes of a particular physical operation of the electronic apparatus. The method 1000 includes the step 1002 of, upon detection of the touch input, activating and/or deactivating one or more respective physical operation and/or modes of a particular physical operation of the electronic apparatus.

It will be appreciated that the aforementioned circuitry may have other functions in addition to the mentioned functions, and that these functions may be performed by the same circuit.

It will be appreciated that the apparatus may have other configurations than those specifically discussed. For example, the apparatus may comprise one or more hinges, for example on one or more lateral sides, such that the apparatus can open and close in the form of a “clam”.

The touch input command may be such that it would not normally be accidentally made (i.e. unlikely to be accidentally made e.g. with a probability of less than approximately 50%, 40%, 30%, 20%, 10%, or 5%), and therefore unlikely to be detected, during ordinary carriage by a user of the apparatus/device comprising the user interface. For example, such touch input commands may not ordinarily be detected during carriage of such a device/apparatus in a pocket/belt-strap/bag of a user.

The applicant hereby discloses in isolation each individual feature described herein and any combination of two or more such features, to the extent that such features or combinations are capable of being carried out based on the present specification as a whole in the light of the common general knowledge of a person skilled in the art, irrespective of whether such features or combinations of features solve any problems disclosed herein, and without limitation to the scope of the claims. The applicant indicates that aspects of the present invention may consist of any such individual feature or combination of features. In view of the foregoing description it will be evident to a person skilled in the art that various modifications may be made within the scope of the invention.

While there have been shown and described and pointed out fundamental novel features of the invention as applied to preferred embodiments thereof, it will be understood that various omissions and substitutions and changes in the form and details of the devices and methods described may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto. Furthermore, in the claims means-plus-function clauses are intended to cover the structures described herein as performing the recited function and not only structural equivalents, but also equivalent structures. Thus although a nail and a screw may not be structural equivalents in that a nail employs a cylindrical surface to secure wooden parts together, whereas a screw employs a helical surface, in the environment of fastening wooden parts, a nail and a screw may be equivalent structures.

1-27. (canceled)

28. A user interface arranged to detect at least one touch input command to control at least one of an activation and deactivation of at least one of a physical operation and mode of a physical operation of an apparatus.

29. A user interface according to claim 28, wherein the at least one touch input command is a swipe command.

30. A user interface according to claim 28, wherein the at least one touch input command is a swipe command in particular direction.

31. A user interface according to claim 28, wherein the user interface comprises at least one touch area such that the at least one touch input command is detectable on at least one face of the apparatus.

32. A user interface according to claim 28, wherein the user interface comprises at least one touch area for at least two faces of the apparatus such that the at least one touch input command is detectable on the at least two faces of the apparatus.

33. A user interface according to claim 28, wherein the user interface comprises at least one touch area to extend over at least two faces of the apparatus such that a particular touch input command is detectable over the at least two faces of the apparatus.

34. A user interface according claim 28, wherein the user interface comprises at least two touch areas for different faces of the apparatus such that the at least one particular touch input command is dedicated for detection on a particular face of the apparatus.

35. A user interface according to claim 28, wherein the user interface is arranged such that a particular touch command is registered when touch areas on different faces of the apparatus are touched in a particular order.

36. A user interface according to claim 28, wherein the user interface is arranged such that the at least one physical operation of the apparatus comprises a particular physical configuration of the apparatus.

37. A user interface according to claim 28, wherein the apparatus comprises a first and second physical configuration, and the touch command is arranged to activate transformation of the apparatus between the first and the second physical configuration.

38. A user interface according to claim 28, wherein the apparatus comprises a first and second physical configuration, and the touch command is arranged to activate biased transformation of the apparatus between the first and the second physical configuration.

39. A user interface according to claim 28, wherein the apparatus comprises a first and second part which overlie one another in a first configuration but which are displaced from each other in a second configuration.

40. A user interface according to claim 28, wherein the at least one physical operation of the apparatus comprises an activation of at least one user output element.

41. A user interface according to claim 28, wherein the at least one physical operation of the apparatus comprises an activation of at least one of a non-touch user input area and another touch user input area.

42. A user interface according to claim 28, wherein the user interface is arranged such that the at least one physical operation of the apparatus comprises a physical function performable by the apparatus.

43. A user interface according to claim 42, wherein the physical function includes at least one of digital image processing, managing a radio communication over the air interface, providing an audio and video output and controlling operation of a second apparatus, wherein the second apparatus is a remote apparatus.

44. A user interface according to claim 28, wherein the apparatus is a hand portable electronic apparatus.

45. A user interface according to claim 28, wherein the apparatus is a hand portable electronic device, such as at least one of a radio telephone, camera and an audio/video player.

46. An apparatus arranged to detect at least one touch input command to control at least one of an activation and deactivation of at least one of a physical operation and mode of a physical operation of the apparatus.

47. A computer program to receive touch user input to control an apparatus, wherein a user interface is arranged to detect at least one touch input command to control at least one of an activation and deactivation of at least one of a physical operation and mode of a particular physical operation of the apparatus.
